(19) United States
(12) Patent Application Publication
(10) Pub. No.: US 2014/0177997 A1
(43) Pub. Date: Jun. 26, 2014

(54) WAVEGUIDE LENS INCLUDING PLANAR WAVEGUIDE AND MEDIA GRATING

(71) Applicant: HON HAI PRECISION INDUSTRY CO., LTD., New Taipei (TW)

(72) Inventor: HSIN-SHUN HUANG, New Taipei (TW)

(21) Appl. No.: 13/925,238

(22) Filed: Jun. 24, 2013

(30) Foreign Application Priority Data
Dec. 24, 2012 (TW) 101149424

(51) Int. Cl. G02B 6/12

(52) U.S. Cl. CPC G02B 6/12004
USPC 385/14

(57) ABSTRACT

A waveguide lens includes a substrate, a pair of electrodes, a planar waveguide, and a grating. The planar waveguide is formed on the substrate and is coupled with a laser light source, which emits a laser beam having a divergent angle into the planar waveguide. The grating is formed on the planar waveguide. The laser light source is attached to a portion of the planar waveguide corresponding to the planar waveguide; the grating and the planar waveguide constitute a ridge-type waveguide lens to converge a laser beam into an optical element. The pair of electrodes is arranged at two opposite sides of the planar waveguide and is configured to change an effective refractive index of the planar waveguide, utilizing an electro-optical effect, when a modulating electric field is applied.

### BACKGROUND

1. Technical Field

The present disclosure relates to integrated optics, and particularly to a waveguide lens.

2. Description of Related Art

Lasers are used as light sources in integrated optics as the lasers have excellent directionality compared to typtical light sources. However, laser beams emitted by the lasers still have an angle of divergence. As such, if the laser is directly connected to an optical element, some rays diverge from the optical element, decreasing light usage.

Therefore, it is desirable to provide a waveguide lens, which can overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric schematic view of a waveguide lens, according to an exemplary embodiment.

FIG. 2 is a cross sectional view of the waveguide lens of FIG. 1.

### DETAILED DESCRIPTION

Embodiments will be described in detail below with reference to the drawings.

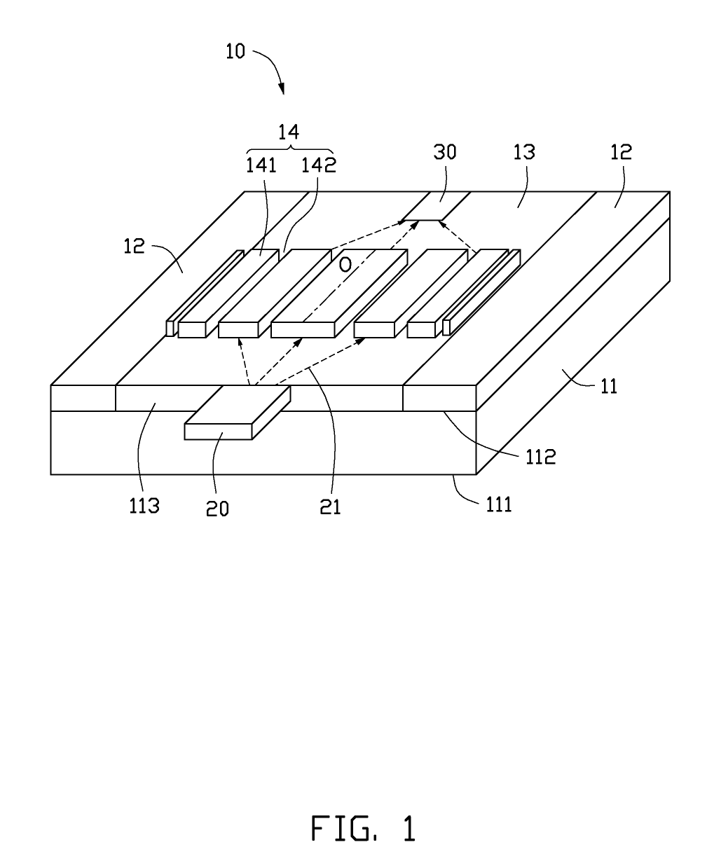

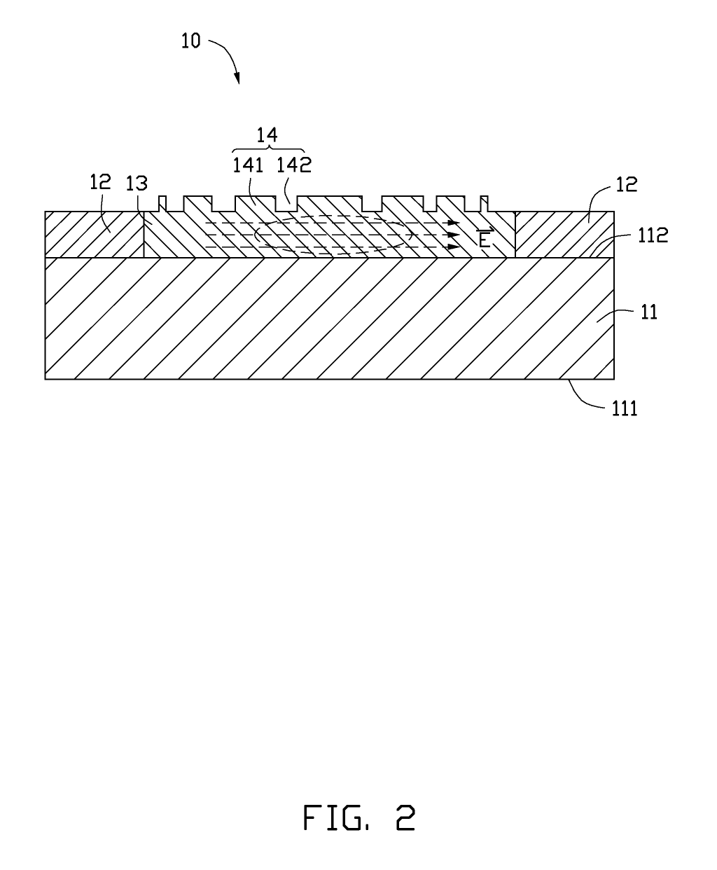

FIGS. 1 and 2 show a waveguide lens 10 according an exemplary embodiment. The waveguide lens 10 includes a substrate 11, a pair of electrodes 12, a planar waveguide 13, and a grating 14.

The substrate 11 is substantially rectangular and includes a first surface 111, a second surface 112, and a side surface 113 connected with the first surface 111 and the second surface 112. The first surface 111 opposite to the second surface 112. In this embodiment, the substrate 11 is made of lithium niobate (LiNbO₃) crystal, but the disclosure is not limited thereto.

The planar waveguide 13 is formed by coating a film of titanium (Ti) on the second surface 112 of the substrate 11 and diffusing the Ti into the substrate 11 by a high temperature diffusion technology. That is the planar waveguide 13 is made of LiNbO3 diffused with Ti (Ti:LiNbO3). The planar waveguide 13 is substantially rectangular in an intermediate area of the second surface 112. After the planar waveguide 13 is formed, the second surface 112 becomes an upper surface of the planar waveguide 13, and the side surface 113 becomes a side surface of the planar waveguide 13.

When the planar waveguide 13 becomes a Ti:LiNbO3, two opposite sides of the planar waveguide are removed by an etching process. That is surface area of the planar waveguide 13 is smaller than the second surface 112.

The pair of electrodes 12 is arranged on the second surface 112 and at two opposite sides of the planar waveguide 13, and a height of the electrode 12 is not more than a height of the planar waveguide 13. In this embodiment, the electrodes are made of aluminum (Al), and are formed on the second surface 112 through a coating method, such as a physical vapor deposition (PVD) method.

The grating 14 is formed by etching the upper surface of the planar waveguide 13 (i.e. the second surface 112). In an exemplary embodiment, an etching solution to etch the upper surface of the planar waveguide 13 is hydrofluoric acid (HF). That is, the grating 14 is also made of Ti:LiNbO₃. After the grating 14 is formed, the second surface 112 is an upper surface of the grating 14. The grating 14 includes a number of strips 141 and a number of gaps 142 between the strips 141. In this embodiment, there are an odd number of the strips 141. The strips 141 are symmetrical about the widthwise central axis O of the grating 14. Each of the strips 141 is parallel to each other. In order form from the widthwise central axis O outwards to each side, width of the strips 141 decrease, and widths of gaps 142 between each two adjacent strips 141 also decrease.

The planar waveguide 13 is coupled with a laser light source 20 which emits a laser beam 21 having a divergent angle into the planar waveguide 13. The grating 14 is arranged along a direction that is substantially parallel with an incident direction of the laser beam 21. The grating 14 and the planar waveguide 13 constitute a ridge-type waveguide lens to converge the laser beam 21 into an optical element 30. A cross section of the grating can be rectangular, square, or trapezoidal shapes.

In other embodiment, a material of the grating 14 can be different from the planar waveguide 13, the material of the grating 14 can be a high reflective index material, and the reflective index of the grating 14 is equal to or greater than the reflective index of the planar waveguide 13.

The laser light source 20 can be a distributed feedback laser (DFB), and is attached to a portion of the side surface 113 corresponding to the planar waveguide 13. An optical axis of the laser light source 20 is aligned with the widthwise central axis O.

The optical element 30 is selected from the group consisting of a strip waveguide, an optical fiber, and a splitter. In the present embodiment, the optical element 30 is a strip waveguide.

When a modulating voltage is applied to the pair of electrodes 12, a modulating electric field Ē will be generated. The pair of first electrodes 12 is configured to change an effective refractive index of the planar waveguide 13, then an effective focal length of the ridge-type waveguide lens of the laser beam 21 is changed, by utilizing an electro-optical effect, when a first modulating electric field Ē is applied. The laser light source 20 is effectively coupled into the optical element 30.

Since the pair of electrodes 12 of the waveguide lens 10 is arranged at two opposite sides of the planar waveguide 13, and the planar waveguide 13 and the pair of electrodes 12 are on the same plane, making a size distribution and a direction of the modulating electric field Ē are substantially parallel with the substrate 11.

Although the present disclosure has been specifically described on the basis of these exemplary embodiments, the disclosure is not to be construed as being limited thereto. Various changes or modifications may be made to the embodiments without departing from the scope and spirit of the disclosure.

What is claimed is:

1. A waveguide lens, comprising:
a substrate comprising a first surface and an opposite second surface;
a planar waveguide formed on the second surface of the substrate, the planar waveguide coupled with a laser light source which emits a laser beam having a divergent angle into the planar waveguide;
a pair of electrodes arranged at two opposite sides of the planar waveguide; and
a grating formed on the planar waveguide;
wherein a surface area of the planar waveguide is smaller than the second surface; the pair of electrodes being configured to change an effective refractive index of the planar waveguide, utilizing an electro-optical effect, when a modulating electric field Ē is applied.

2. The waveguide lens as claimed in claim 1, wherein the laser light source is attached to a portion of the planar waveguide corresponding to the planar waveguide; the grating and the planar waveguide constitute a ridge-type waveguide lens to converge a laser beam into an optical element.

3. The waveguide lens as claimed in claim 2, wherein the optical element is selected from the group consisting of a strip waveguide, an optical fiber, and a splitter.

4. The waveguide lens as claimed in claim 1, wherein the substrate is made of lithium niobate (LiNbO₃) crystal.

5. The waveguide lens as claimed in claim 4, wherein the substrate is substantially rectangular, and a side surface is connected with the first surface, and the second surface.

6. The waveguide lens as claimed in claim 1, wherein the electrodes are made of aluminum (Al), and are formed on the second surface through a coating method.

7. The waveguide lens as claimed in claim 6, wherein a height of the electrode is not more than a height of the planar waveguide.

8. The waveguide lens as claimed in claim 1, wherein the planar waveguide is formed by coating a film of titanium (Ti) on the second surface and diffusing the Ti into the substrate by a high temperature diffusion technology.

9. The waveguide lens as claimed in claim 8, wherein the planar waveguide is substantially rectangular in an intermediate area of the second surface; a surface area of the planar waveguide is smaller than the second surface.

10. The waveguide lens as claimed in claim 1, wherein the grating is formed by etching the upper surface of the planar waveguide.

11. The waveguide lens as claimed in claim 10, wherein the etching uses hydrofluoric acid (HF).

12. The waveguide lens as claimed in claim 10, wherein the grating is made of lithium niobate crystal diffused with titanium.

13. The waveguide lens as claimed in claim 10, wherein the grating comprises a number of strips and a number of gaps between the strips, wherein there are an odd number of the strips; the strips are symmetrical about the widthwise central axis O of the grating; each of the strips is parallel to each other.

14. The waveguide lens as claimed in claim 10, wherein a material of the grating is different from the planar waveguide, the material of the grating is a high reflective index material, and a reflective index of the grating is equal or greater than a reflective index of the planar waveguide.

15. The waveguide lens as claimed in claim 10, wherein a cross section of the grating is rectangular, square, or trapezoidal shapes.
